(19) United States
(12) Patent Application Publication
(10) Pub. No.: US 2019/0050935 A1
(43) Pub. Date: Feb. 14, 2019

(54) Device And Method For Exchange Market

(71) Applicant: Walid Ahmed Fouad Ahmed Rashwan, Dubai Marina (AE)

(72) Inventor: Walid Ahmed Fouad Ahmed Rashwan, Dubai Marina (AE)

(21) Appl. No.: 16/076,613

(22) PCT Filed: Feb. 8, 2017
(86) PCT No.: PCT/IB2017/000084

§ 371 Date: Aug. 8, 2018

Related U.S. Application Data
(60) Provisional application No. 62/292,716, filed on Feb. 8, 2016.

(51) Int. Cl. G06Q 30/06; G06F 17/30

(52) U.S. Cl. CPC G06Q 30/0635; G06F 17/30867; G06F 17/30554; G06F 17/3053

(57) ABSTRACT

A method for implementing an exchange market involves gathering, from a multitude of users, a multitude of wish lists including a multitude of marketable products and gathering, from a multitude of users, a multitude of offer lists including a multitude of marketable products. The method continues by matching, using a data structure, a selection of marketable products from the multitude of offer lists stored in the data structure to a selection of marketable products from the multitude of wish lists stored in the data structure to identify a multitude of matches, assigning a ranking value to each of the multitude of matches based on information stored in the data structure, positioning the multitude of matches according to the ranking value to obtain an ordered list, and presenting the multitude of matches according the ordered list.

### BACKGROUND

Exchange market systems provide a mechanism for entities to develop transactions through a computing network. Users for example, have to manage multiple products they seek to buy, sell and exchange with other users simultaneously. Management of the lists with these products is complex and may be confusing due to the amount of decisions they have to make in the same time in order to identify a better deal from multiple points of view. Each product can be transacted in more than one way and a user interested in transaction has to decide which is the best way based on unbiased elements. In addition, users involved in a transaction and remotely located from each other would benefit from a communication channel that would allow them to negotiate additional elements of the deal.

Computer networks provide a mechanism for individuals who do not know each other to communicate. Because of the complexity, with respect to deal selection, user communication, payments for the products transacted, and shipping arrangements for the products transacted, a user attempting to engage in a transaction deal is currently unable to process the transaction in a unified interface.

### SUMMARY

In general, in one aspect, the invention relates to a method for implementing an exchange market comprising gathering, from a first plurality of users, a plurality of wish lists comprising a first plurality of marketable products; gathering, from a second plurality of users, a plurality of offer lists comprising a second plurality of marketable products; matching, using a data structure, a selection of marketable products from the plurality of offer lists stored in the data structure to a selection of marketable products from the plurality of wish lists stored in the data structure to identify a plurality of matches; assigning a ranking value to each of the plurality of matches based on information stored in the data structure; positioning the plurality of matches according to the ranking value to obtain an ordered list; and presenting the plurality of matches according to the order list.

In general, in one aspect, the invention relates to an exchange computing device, comprising a computer processor; and an exchange market application. The exchange market application executes on the computer processor and configured to: gather, from a first plurality of users, a plurality of wish lists comprising a first plurality of marketable products; gather, from a second plurality of users, a plurality of offer lists comprising a second plurality of marketable products; match a selection of marketable products from the plurality of offer lists to a selection of marketable products from the plurality of wish lists to identify a plurality of matches; assign a ranking value to each of the plurality of matches; positioning the plurality of matches according to the ranking value to obtain an ordered list; and present the plurality of matches according to the ordered list.

In general, in one aspect, the invention relates to a non-transitory computer readable medium comprising instructions, which when executed on a computer processor, cause a computer to perform: gathering, from a first plurality of users, a plurality of wish lists comprising a first plurality of marketable products; gathering, from a second plurality of users, a plurality of offer lists comprising a second plurality of marketable products; matching a selection of marketable products from the plurality of offer lists to a selection of marketable products from the plurality of wish lists to identify a plurality of matches; assigning a ranking value to each of the plurality of matches; positioning the plurality of matches according to the ranking value to obtain an ordered list; and presenting the plurality of matches according to the ordered list.

Other aspects of the invention will be apparent from the following description and the appended claims.

### BRIEF DESCRIPTION OF DRAWINGS

FIG. 1 shows a schematic diagram of a system in accordance with one or more embodiments of the invention.

FIGS. 2, 3.1, 3.2, show flowcharts in accordance with one or more embodiments of the invention.

FIG. 4 shows an example a timeline of a set of user interactions in accordance with one or more embodiments of the invention.

FIGS. 5, 6, 7.1, 7.2, 7.3, and 7.4 show examples in accordance with one or more embodiments of the invention.

FIG. 8.1 shows a computer system in accordance with one or more embodiments of the invention.

FIG. 8.2 shows a network system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention are directed to an exchange market that facilitates two way and one way exchanges of marketable products, where a product may be purchased or bartered. In one or more embodiments, users submit offer lists that include marketable products in possession of the user. These marketable products are ones the user would like to barter or sell. Likewise, the users may submit wish lists that include marketable products that the user would like to purchase or barter for. The system matches the offer lists and wish lists of different users to obtain possible one way and two way matches. A two way match is a match that exchanges products for products or products for products as well as money. A one way match is a match that exchanges products for money.

In one or more embodiments, the system assigns values to the matches based on the values of the products, geographic location, and whether the match is for barter (i.e., a two way match) or purchase (i.e., a one way match). These values and storing of the values in tables of a data structure (such as a self-referential table) allows for robust and innovative matching. The system may also use other parameters in evaluating matches. The system then presents the matches and can assist with the negotiation between users using the same data structure and the values stored therein.

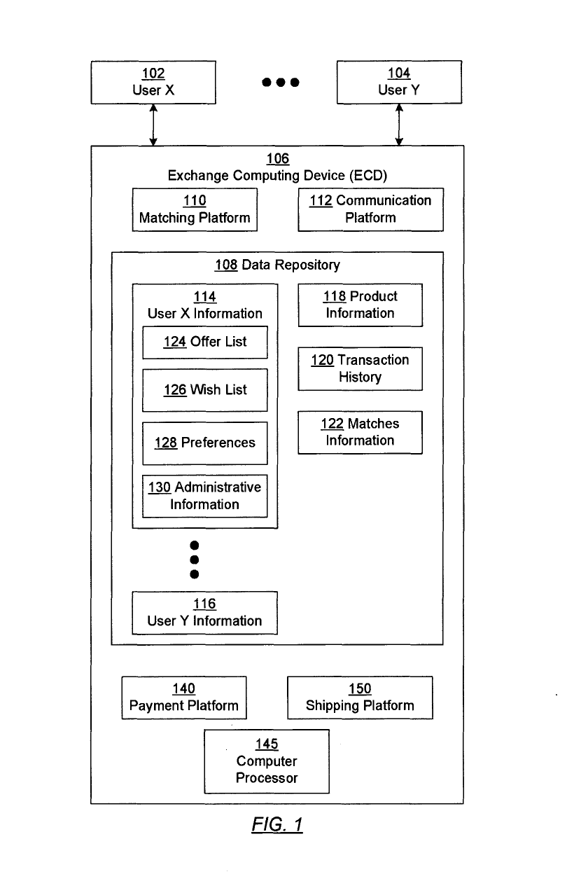

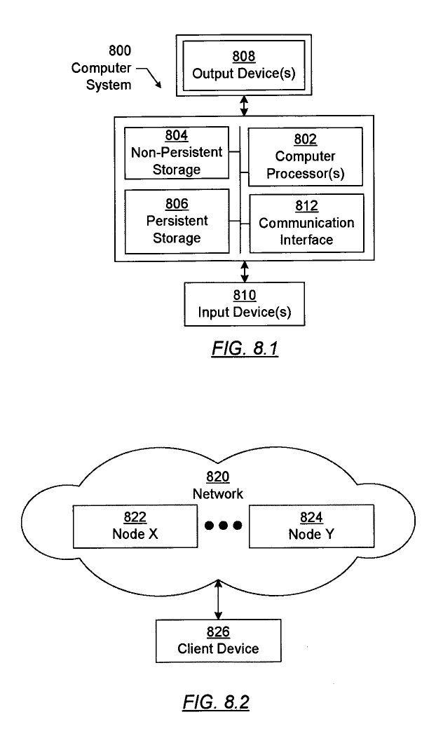

FIG. 1 shows a system of an exchange computing device (ECD) in accordance with one or more embodiments of the invention. As shown in FIG. 1, the system includes multiple users (102, 104) and an exchange computing device (106). The exchange computing device (106) includes a computer processor (145) and is configured to operate the exchange market application (not shown) in accordance with one or more embodiments of the invention. For example, the exchange computing device may be the computing device shown in FIG. 8 with a similar computer processor as shown in FIG. 8 and described below. The exchange computing device (106) may include a data repository (108), a matching platform (110), and a communication platform (112).

In one or more embodiments of the invention, the data repository (108) is any type of storage unit and/or device (e.g., a file system, database, collection of tables (such as self-referential tables) or data structures of any kind, or any other storage mechanism) for storing data. Further, the data repository (108) may include multiple different storage units and/or devices. The multiple different storage units and/or devices may or may not be of the same type or located at the same physical site. The data repository (108) may include functionality to store user information (114, 116) for users (102, 104), product information (118), transaction history (120), and matches information (122). User information (114, 116) includes information about a user, such as offer list (124), wish list (126), preferences (128), and administrative information (130).

The offer lists (124) are lists of marketable products that the user has and would like to sell or exchange for other marketable products. In one or more embodiments, a marketable product is a physical good or service belonging to a user and exchangeable for money, other goods, other services, or a combination thereof. For example cars, women bags, spices, fruit harvesting help, etc. Each marketable product in the offer list has a corresponding product value that the user associates with the marketable product. In one or more embodiments, the system may suggest the value for the marketable product.

The wish lists (126) are lists of marketable products that the user would like to purchase or exchange for other marketable products. Each marketable product in the wish list has a corresponding product value that the user associates with the marketable product. In one or more embodiments, the system may suggest the value for the marketable product.

The preferences (128) are a set of parameters for interacting with the user. In one or more embodiments, preferences determine the information that is presented to the user, are used to trigger automatic events, and provide a mean for the user to customize the product exchange process. For example, preferences may include number and types of communications and notifications, how information is displayed or otherwise presented to the user, and any other information.

The administrative information (130) are information for identifying a user. In one or more embodiments, the administrative information (130) includes information about user identity, location, financial and shipping accounts. For example, administrative information may include name, address, geographic region, bank account, shipping instructions, transport preferences, and other-information.

The product information (118) is information about each marketable product being transacted. In one or more embodiments, the product information is used to determine whether a match may be established with other marketable product. For example, product information may include one or more stock photographs, retail value, manufacturer, description, version number, degree of usage and wear, and other information.

The transaction history (120) is information about historical transactions. In one or more embodiments, the transaction history records parameters of transactions performed and may be used to evaluate the quality of the past transactions. In one or more embodiments, the transaction history may be used to rate the reliability of the users involved in a current transaction in order to negotiate a better deal. In other words, the transaction history may include identification of the value of the transaction, transportation costs, identification of products, price, and other information. For example, a transaction history may be a transaction record, a review, a user rating, an invoice, or another unique description of the transaction. In one or more embodiments, the user rating is based on, number of transactions, feedback from other users, lack of any serious complaints, and any other user information. The transaction history may be related in the data structure of the data repository to a user identifier and to one or more marketable product identifiers.

The matches information (122) is information about current matches. A match is a mapping relationship between a marketable product from an offer list and a marketable product from a wish list. In one or more embodiments, if a match exists between a marketable product from an offer list and a marketable product from a wish list, the marketable products are matched. In one or more embodiments, a match may be a one way match or a two way match. In one or more embodiments, a one way match is established when at least one match between a marketable product from a wish list of a first user, and a marketable product from an offer list of a second user exists. In one or more embodiments, a two way match is established when at least one match between a marketable product from a wish list of a first user, and a marketable product from an offer list of a second user exists and simultaneously at least one match between a marketable product from an offer list of the first user, and a marketable product from an wish list of the second user exists.

In one or more embodiments, matches information (122) may include information about possible matches and information about selected matches for presentation. For example, matches information may include the ranking value of the match, product identifier, price of each individual product, unique identifiers for each user, geographic location of users, and other information. In one or more embodiments, the ranking value is an index characterizing the match and used to determine the quality of a potential transaction of the marketable products in the match. For example, the ranking value may be used to estimate the overall profit from the deal if an exchange is performed between the marketable products in the match.

The matching platform (110) is a software tool that includes functionality to match marketable products from offer lists with marketable products from wish lists, assign a ranking value to the matches, and present the matches. In one or more embodiments, for any match the matching platform (110) may be configured to determine if the match become a transaction based on the preferences (128) of a user, based on matches information (122), or as a result of a user input.

The communication platform (112) includes functionality to facilitate communication between users for a particular match. In particular, the communication platform (112) may act as the intermediary between users. In one or more embodiments, the communication platform (112) is configured to create a communication channel between users in order for a user to interact with another user. In one or more embodiments, the interacting users may provide additional information about the matched marketable products through the communication platform (112). For example, the users may engage in a deal negotiation through the communication platform.

The payment platform (140) includes functionality to process and manage monetary transactions for users. The payment platform (140) includes functionality to store monetary transaction in the transaction history (120). In one or more embodiments, the payment platform (140) is configured to receive information about a marketable product transaction and transfer funds between user financial accounts based on the information about the marketable product transaction and user administrative information (130).

The shipping platform (150) includes functionality to process shipping requests. The shipping platform (150) includes functionality to store the status of shipping operation in the transaction history (120). In one or more embodiments, the shipping platform (150) is configured to receive information about a marketable product transaction and instruct a shipping operator to transport marketable products among users based on the administrative information (130) associated with each user engaged in the transaction.

While FIG. 1 shows a configuration of components, other configurations may be used without departing from the scope of the invention. For example, various components may be combined to create a single component. As another example, the functionality performed by a single component may be performed by two or more components.

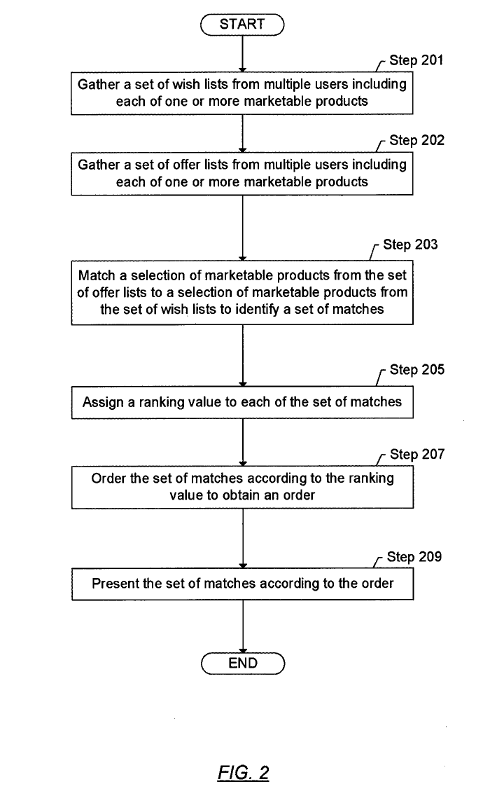

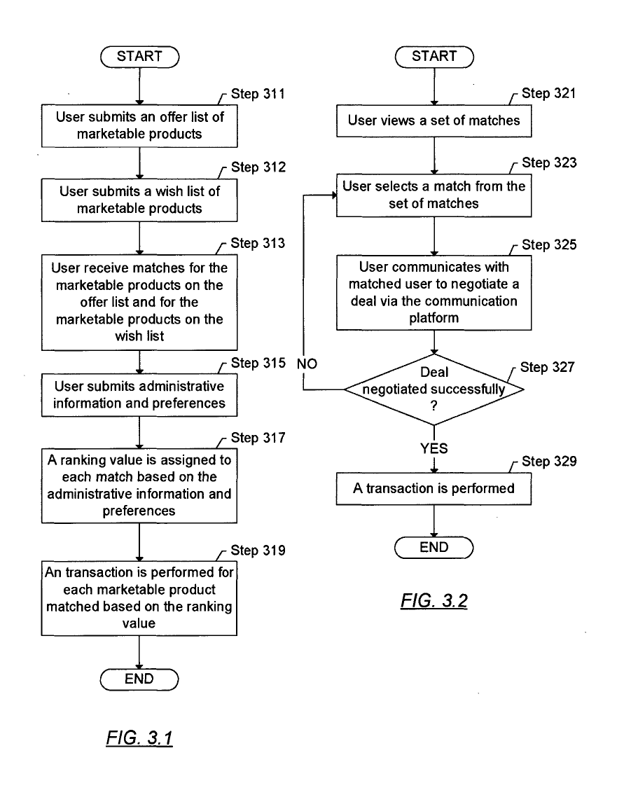

FIGS. 2, 3.1, 3.2, 4, 5, 6, 7.1, 7.2, 7.3, and 7.4 show flowcharts in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention.

FIG. 2 shows a flowchart for a system of an ECD to process transactions in accordance with one or more embodiments of the invention.

In Step 201, the system gathers a set of wish lists from multiple users, including each one or more marketable products. In one or more embodiments, each wish list is submitted by a user to the exchange computing device and stored in the exchange computing device's data repository. In one or more embodiments, the wish list submitted is associated with the user who submitted the wish list. For example, user X and user Y submit each a list of marketable products they are interested to purchase. In one or more embodiments, the wish lists may be submitted by users by entering in a user interface a complete description of marketable products, a partial description of marketable products and use predictive text enabled feature to complete the description of marketable products, or by using image recognition technology to identify and select marketable products. In one or more embodiments, the marketable products from each wish list are integrated in the data repository of the ECD and offered to all users as a pool of wanted marketable products. In one or more embodiments, each user may continuously update his wish list.

In Step 202, the system gathers a set of offer lists from multiple users including each one or more marketable products. In one or more embodiments, each offer list is submitted by a user to the exchange computing device and stored in the exchange computing device's data repository. In one or more embodiments, the offer list submitted is associated with the user who submitted the offer list. For example, user X and user Y submit each a list of marketable products they are interested to sell or exchange. In one or more embodiments, the offer lists may be submitted by users by entering in a user interface a complete description of marketable products, a partial description of marketable products and use predictive text enabled feature to complete the description of marketable products, or by using image recognition technology to identify and select marketable products. In one or more embodiments, the marketable products from each offer list are integrated in the data repository of the ECD and offered to all users as a pool of available items. In one or more embodiments, each user may continuously update his offer list.

In Step 203, the system matches a selection of marketable products from the set of offer lists to a selection of marketable products from the set of wish lists to identify a set of matches. In one or more embodiments, the marketable platform of the exchange computing device determines a match based on user preferences and product information. In one or more embodiments, the matching platform of the exchange computing device is reading each marketable product from all wish lists and identify each matching marketable products on any of the offer lists based on preferences of the user owning the wish list or the offer list containing the marketable product and based on product information of the marketable product.

In one or more embodiments, when a match is found, the match is added to the set of matches associated with a marketable product. In one or more embodiments, a set of matches is associated with each marketable product from the wish lists and with each marketable product from the offer lists. For example a marketable product from a wish list may be matched to multiple marketable products each on a different offer list. In one or more embodiments, the system may retrieve product information for marketable products available on entities not in the system (i.e., external sellers) and match marketable products from the system data repository with marketable products available on entities not in the system.

In one or more embodiments, the matching platform is sequentially searching through the product information records of the marketable products from each wish list, and selects for each marketable product a set of matched marketable product from an offer list with product information satisfying a set of criteria defined by user preferences to obtain a set of matches. In one or more embodiments, the matching platform is continuously searching through the product information records to obtain an update of the product information records.

In Step 205, the system assigns a ranking value to each of the set of matches. In one or more embodiments, the ranking value is a reflection of how well the match may satisfy the desire of the users. For example, the ranking value may be a summation of actual price, retail price, or other price of each of the products decreased by the projected transportation costs. In one or more embodiments, the matching platform calculates a ranking value for a match based on user preferences and product information. In one or more embodiments, a ranking value is assigned to each match in the set of matches associated with each marketable product from wish lists and offer lists. For example, a ranking value may be associated with a match based on the marketable product price as read from the product information associated with the marketable product of the offer list.

By way of another example, a ranking value may be associated with a match based on the transportation cost from the geographic location of the user associated with the offer list. The system may estimate transportation costs based on actual estimates or prices provided by transportation companies, geographic distance, whether and/or which borders of countries are crossed, other factors, or a combination of factors. In one or more embodiments, the ranking value of the match may be increased or decreased based on preferences of one or both users associated with the match regarding how much the user is willing to pay for a good.

The system may also use other parameters to determine the ranking value of matches. In one or more embodiments, the ranking value of the match may be calculated taking into account the value of recycled marketable products and displayed to users to show how much the system has contributed to reducing overall carbon footprint. Recycled marketable products are products that are exchanged via the system.

In one or more embodiments, the ranking value for a match may be calculated using integrating or aggregating algorithms. In one or more embodiments, the algorithms may integrate or aggregate user information and product information by performing weighting average on various parameters from user information and product information. For example, the algorithms my aggregate or integrate age of the product, condition of the product, availability of stock, number of successful transactions done by the offering user, rating average of the offering user, and any other information. In one or more embodiments, the ranking value may combine valuation results. For example, the ranking value of product sold vs. product purchased in an exchange and or direct sale or purchase, ranking value plus shipping charges, total transaction value vs. shipping charges, ranking value plus cost of additional requirement such as independent valuation. In one or more embodiments, the ranking value will enable comparison among various marketable products.

In one or more embodiments, the ranking value may be used to determine a fair value for a marketable product not in sale by any retailer. In other embodiments, the ranking value may be the lowest price or other statistic regarding price. In one or more embodiments, a quality guarantee service may be included, where independent valuation of a marketable product is added as a service. Further, a security hold on the payment gateways may be implemented allowing for securing of high value transactions. For example the security hold may be applied for luxury products. At least one of the above may be calculated using the using integrating or aggregating algorithms to assist the user to select the best match.

In Step 207, the system orders the set of matches according to the ranking value to obtain an order. In one or more embodiments, the matching platform read the ranking values of the matches in each set of matches and order them according to a criteria defined in user preferences. For example, the matches for a marketable product associated with an offer list are ordered according to the distance to the location of matched products on various wish lists. In one or more embodiments, the system may order the possible matches based on subscriber status. For example, subscribers to the system, with a fee, may obtain preferential treatment (e.g., view matches first, have their matches increased artificially in value, or other preferential treatment) when receiving matches.

In Step 209, the system presents the set of matches according to the order. In one or more embodiments, the ordered set of matches associated with each marketable product on each wish list and each offer list is presented to the user associated with each wish list and each offer list. In one or more embodiments, matches may be presented in the user interface of the exchange market, in an electronic communication, by way of another form of presentation. In some embodiments, only independent sets of marketable products are presented as possible matches. In other embodiments, sets of marketable products in different matches may overlap. In accordance with one or more embodiments of the invention, as products are transacted, the matches presentation is continually updated. For example, if a product is sold that is in multiple presented matches, the product is removed from the presented matches and the matches are revalued.

In one or more embodiments, a proactive set of matches may be presented. A proactive set of matches includes additional marketable products that may exist in the wish list or offer list of each user associated with a match being presented.

FIGS. 3.1 and 3.2 show flowcharts from a user perspective in accordance with one or more embodiments of the invention.

FIG. 3.1 shows a flowchart to perform a transaction on a system of an exchange computing device without user input.

In Step 311, a user submits an offer list of marketable products. In one or more embodiments, the user submits the offer list through the system's user interface to be saved in the system's data repository. In one or more embodiments, the user may add new marketable products to an offer list already saved in the system's data repository. The user may add the new marketable products independently, as a result of another user request or as a result of a deal negotiation. In one or more embodiments, the user may use wizard build into the system that guides the user through submitting marketable products for offer list.

In Step 312, the user submits a wish list of marketable products. In one or more embodiments, the user submits the wish list through the system's user interface to be saved in the system's data repository. In one or more embodiments, the user may add new marketable products to a wish list already saved in the system's data repository. The user may add the new marketable products independently, as a result of an opportunity for a deal, or as a result of a deal negotiation. In one or more embodiments, the user may use wizard build into the system that guides the user through submitting marketable products for wish list.

In Step 313, the user receives matches for the marketable products on the offer list and for the marketable products on the wish list. In one or more embodiments, the system search through the data repository and select all marketable products found in the data repository that matches the marketable products on the offer list and on the wish list submitted by the user. In one or more embodiments, the system may select the matches based on a set of specified product information as present in the system's data repository or read from an external data repository. For example, the system may select the matches based on specified product name, specified product dimensions, and geographic location of the product. In other words, the system may select all marketable products found in the database that have the specified name, specified dimensions and are located in the specified geographic zone as the product information in the user offer list and wish list. Further, the matches selected are saved in the system's data repository as matches information associated with user.

In one or more embodiments, the system will keep checking for the matches between marketable products on the offer lists and marketable products on the wish lists and is continuously updating the user on a periodic basis as per user preferences. For example, the user may be notified immediately, daily, weekly, or any other predetermined period. In one or more embodiments, the user may configure the system to place a marketable product on hold for a predefined amount of time where only a selection of preapproved users may have access to the marketable products before being released on the whole system for matching.

In Step 315, the user submits administrative information and preferences. In one or more embodiments, the user submits administrative information and preferences through the system's user interface to be stored in the system data repository. For example, the user may submit banking information, address, shipping preferences, product condition preference, or any information and preference.

In Step 317, a ranking value is assigned to each match based on the administrative information and preferences. In one or more embodiments, the system calculate a ranking value for each match of a marketable product from the offer list and wish list according to a predetermined algorithm and based on the user administrative information and preferences. In one or more embodiments, the algorithm is configured to integrate multiple transaction valuation criteria in order to provide a ranking value to be used to compare multiple matches. For example, the system assigns ranking values to the matches based on the values of the products, geographic location, and whether the match is for barter (i.e., a two way match) or purchase (i.e., a one way match).

In one or more embodiments, the system may calculate a ranking value based on the monetary value of the marketable items, user reliability as defined by a user ranking system, distance between the location of the marketable products in the match. In one or more embodiments, the system may calculate a ranking value based on the best maximum match. In other words, the ranking value represents the total value of the potential transaction. For example, the total value may be net of expenses and charges.

In Step 319, a transaction is performed for each marketable product matched based on the ranking value. In one or more embodiments, the system compare all matches for each marketable product on the offer list and on the wish list according to the match ranking value and select the match having the biggest ranking value. Further, the system executes a transaction for each match having the biggest ranking value. In other words the system mediates an exchange for each marketable product on the offer list and on the wish list of the user and the corresponding marketable product of the selected match. In one or more embodiments, the exchange may be for another marketable product (i.e., a two way match), for an amount of money (i.e., a one way match), or a combination thereof. In one or more embodiments, the system may charge the user for delivery and handling, for services rendered, for inspection of the marketable products, for subscription services, for release of information or any other fee.

In one or more embodiments, the transaction may be between marketable products of different category and location. In other words, the system may generate a transaction for a specific marketable product in a specific location to be exchanged for a similar or different marketable product in a different location. For example, a person moving back to England may trade an apartment in Dubai for another in the England, or may trade a car in Dubai for a set of furniture in England.

In one or more embodiments, the transaction may be performed even when the user is not connected to the system. In other words, the system may automatically approve a transaction request even when the user is not available for confirmation. In one or more embodiments, the automated approval is a configurable parameter that the user may set on a per marketable product basis and/or a default for all marketable products on the user lists. In some embodiments, after a configurable amount of time since a transaction request is sent (e.g., 48 hours or other time), if a response is not received, the system will provide alternatives to the requesting user.

FIG. 3.2 shows a flowchart to perform a transaction on a system of an exchange computing device with user input.

In Step 321, a user views a set of matches. In one or more embodiments, the user views a set of matches for a marketable product from an offer list or from a wish list the user submitted to the system. In one or more embodiments, the user may view the set of matches ordered based on a ranking value of the matches. In one or more embodiments, the user may view a set of matches as presented at step 209 in FIG. 2. For example, the user may view a set of matches for a marketable product ordered in the increasing distance to the matched product location. In one or more embodiments, the user may view the set of matches as prompted by a regular notification from the system, based on the user preferences and marketable product information in order to initiate a transaction or a deal negotiation. In one or more embodiments, the user may be presented with stock photos stored on ECD data repository for the marketable products in the viewed set of matches.

In one or more embodiments, the user may view the set of matches as a result of a filtering operation executed by the user on the ECD user interface. In one or more embodiments, the filtering operation may be performed based on various parameters from the product information. The filtering operation may provide more pointed search options. For example, the filtering operation may provide an option to look for marketable products of a certain category for sale only, for exchange, or for either sale or exchange. For example, the filtering operation may provide an option to look for console games only. The system may perform other filtering without departing from the scope of the invention. The other filtering may be for marketable products from a different category. For example, once other verticals are set the system will also facilitate for cross category search and exchange options based on specific category needs.

In one or more embodiments, the user may view the matches based on location information. In one or more embodiments, the set of matches viewed may take into consideration the proximity of the matched marketable products to allow for more cost efficient options. For example, users may search what's available in the “neighborhood” and do a “neighborhood search” to view only marketable products available in the neighborhood. The “neighborhood search” allows users to select the easiest exchanges and or purchases and go and physically perform a transaction.

In one or more embodiments, the user may view the matches based on the user offer list and the wish lists of other users in the system, but not the wish list of the current user. For example, the system may say “Based on the products you have, you can get the following products in exchange with a product in your offer list.” In other words, the system may list marketable products offered by other users that have a matching marketable product on the offer list of the user.

In Step 323, the user selects a match from the set of matches. In one or more embodiments, the user evaluates the deal associated with the selected match based on the ranking value of the match. In one or more embodiments, the user may select a match based on the order or based on any other criteria. For example, the user may select a match corresponding to the closest distance to the matched marketable product location or the user may select the match based on the lowest shipping expenses. In one or more embodiments, the match is between a marketable product associated with the user and a marketable product associated with another user. For example, a match may be between a marketable product from the user wish list and a marketable product from another user offer list.

In Step 325, the user communicates with matched user to negotiate a deal via the communication platform. In one or more embodiments, the user may activate a communication channel on the communication platform and start a deal negotiation with the user associated with the matched marketable product. In one or more embodiments, the user may receive additional information about the matched marketable product through the communication channel. For example, the user may receive a real photo of the matched marketable product that will be shared between the users involved in the deal negotiation. In one or more embodiments, during the negotiation the user may modify at least one product information or preference in order to change the ranking value of the match. For example, the user may change the conditions of the match, such as price, the goods exchanged, who pays for shipping, and other information. In at least some embodiments, the users may converse and/or exchange money and/or goods via the system. In one or more embodiments, based on the new ranking value the deal is reevaluated.

In Step 327, a decision is made based on the reevaluated deal. If the deal was not negotiated successfully a new match is selected by the user in step 323. In one or more embodiments, if the deal was not negotiated successfully the user may select another match from the set of matches and start a new deal negotiation process with another user.

In Step 329, if the deal was negotiated successfully a transaction is performed. In one or more embodiments, if the deal was negotiated successfully the system facilitates an exchange process between the marketable products associated with the negotiated deal. For example, the system may further facilitate the exchange by managing the exchange of money, holding money or products as a deposit until receipt is confirmed or goods are deemed authentic, authenticating and appraising the products, and performing other actions. Further, the system may suggest other marketable products that may be available on user wish list or similar marketable products that are available on the pool of available marketable products.

In one or more embodiments, the system may calculate an aggregate ranking value across a specific marketable product, whilst also providing various options for transaction with various ranking value to the user to check immediately during the transaction. Once the marketable product has been transacted the system may automatically update the aggregate ranking value of actual transactions. This may assist in reflecting actual fair value of a specific marketable product at a point in time. The aggregate ranking value may be the average price, lowest price, or other set price.

In one or more embodiments, the system may propose a selection of choices to perform the transaction. For example, the system will automatically show transaction options of marketable products between the two users involved in the deal negotiation. In one or more embodiments, a transaction option presented may be a straight barter deal, where the marketable products being transacted have the exact same value. In one or more embodiments, a transaction option presented may be a barter deal of various marketable products or one marketable product on both sides of the transaction but with additional cash paid on top to match the total value between the two users involved in the deal negotiation. In one or more embodiments, a transaction option presented may use cash for item deal, where one user wishes to buy a marketable product without having another marketable product to offer, that the other user wants. In one or more embodiments, the transaction may be between marketable products of different categories. For example, the user may trade games for a tablet computer or other products. The system may allow for instant comparison and for user to make a straight decision on the transaction.

In some embodiments, the system may allow for renting specific marketable products from other users in exchange for a hold guarantee. The system may service the rental for a facilitation fee, and/or subject subscription fee. The fee may be for the marketable product vs. cash per day or marketable product vs. marketable product.

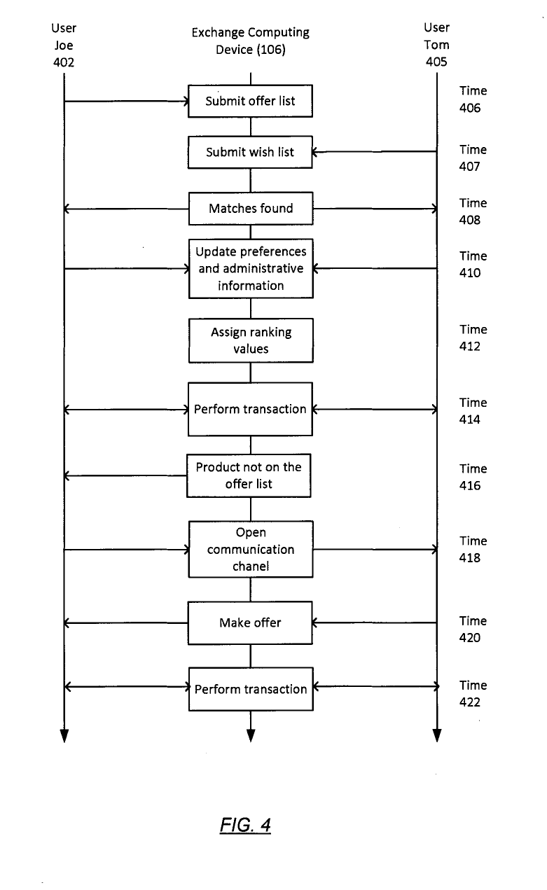

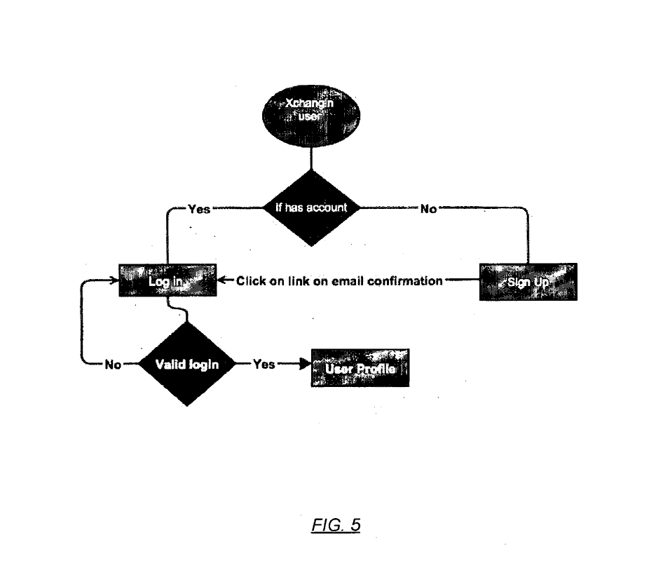

FIG. 4 show an example a timeline of a series of interactions between a user Joe (402) and a user Tom (404) to perform a transaction on a system of an exchange computing device (106).

User Joe decided to disassemble his old car and offer various car parts for sale. Beginning with time (406), user Joe selects a set of car parts that are still in good working condition and submit the selected car parts as an offer list of car parts for sale or exchange. Further, at time (407) user Tom (405) is looking for used car parts to fix a similar model of car and submit an wish list of car parts he is in need to repair his car. At time (408), the system obtains a match of the car parts needed by user Tom (405) and offered by user Joe (402). The system send notification to user Tom (405) and user Joe (402) with the list of matches found. At time (410), user Tom (405) and user Joe (402) update their preferences and administrative information in the system. At time (412), the system assign a ranking value to the matches according to one or more embodiments and select a set of matches for transaction based on the ranking value and user preferences.

At time (414), the system executes transaction on behalf of user Tom (405) and user Joe (402) by initiating the shipping operation for the car parts from user Joe (402) to user Tom (405) and by charging the financial account of user Tom (405) for the list of car parts selected for transaction. At time (416), the system send a notification to user Joe about a car part on user Tom (405) wish list that is not on offer list user Joe submitted initially. User Tom (405) requests the car part and set the car part specification as “in any condition”. User Joe (402) adds the part to the offer list and set the car part specification as “not in good working condition”. At time (418), user Joe (402) open a communication channel and start a deal negotiation process with user Tom for the car part not on the initial offer list. At time (418), user Tom (405) makes an offer to user Joe (402) for the car part and is accepted by user Joe (402). At time (422), the system executes transaction on behalf of user Tom (405) and user Joe (402) by initiating the shipping operation for the car parts from user Joe (402) to user Tom (405) and by charging the financial account of user Tom (405) for the additional car part selected for transaction.

FIGS. 5, 6, 7.1, 7.2, 7.3, and 7.4 show examples of workflows in accordance with one or more embodiments of the invention.

FIG. 5 shows an example workflow of a user authentication within a system of an exchange computing device system in accordance with one or more embodiments of the invention.

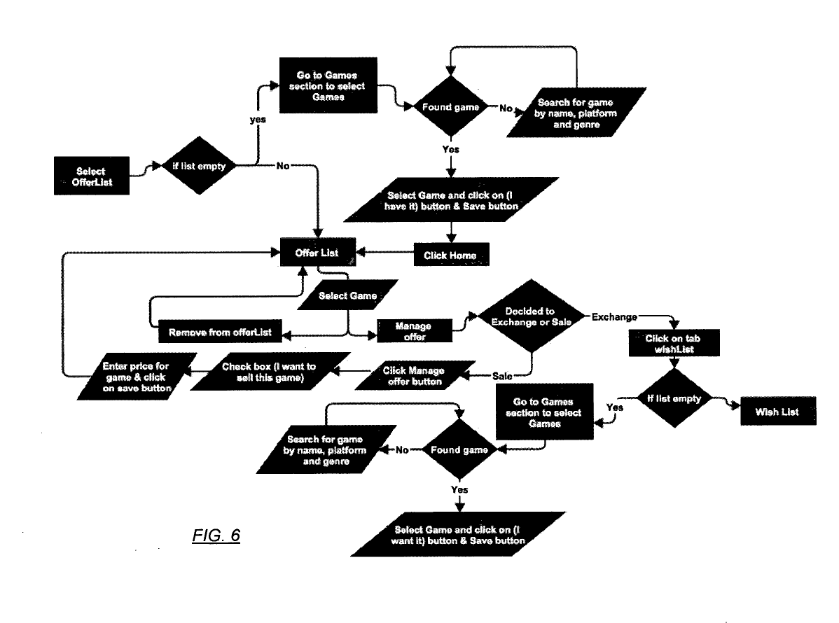

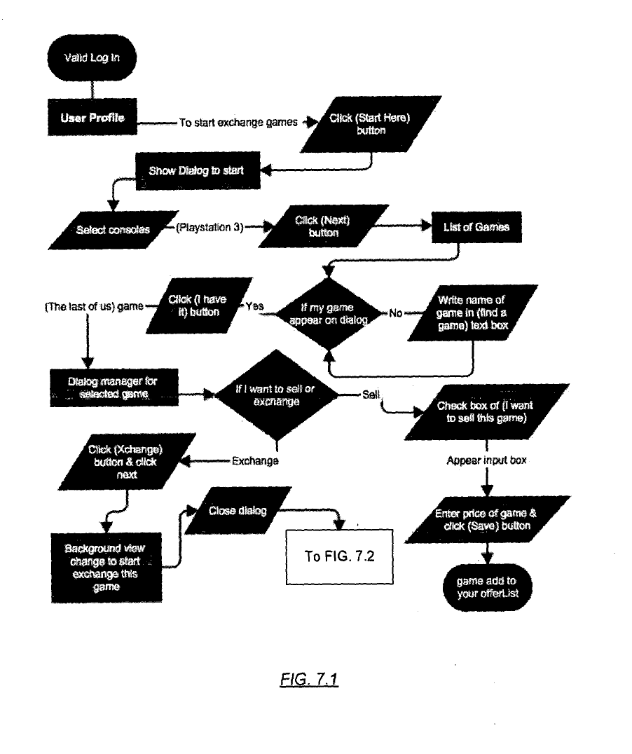

FIG. 6 shows an example workflow of game selection procedure within a system of an exchange computing device system in accordance with one or more embodiments of the invention.

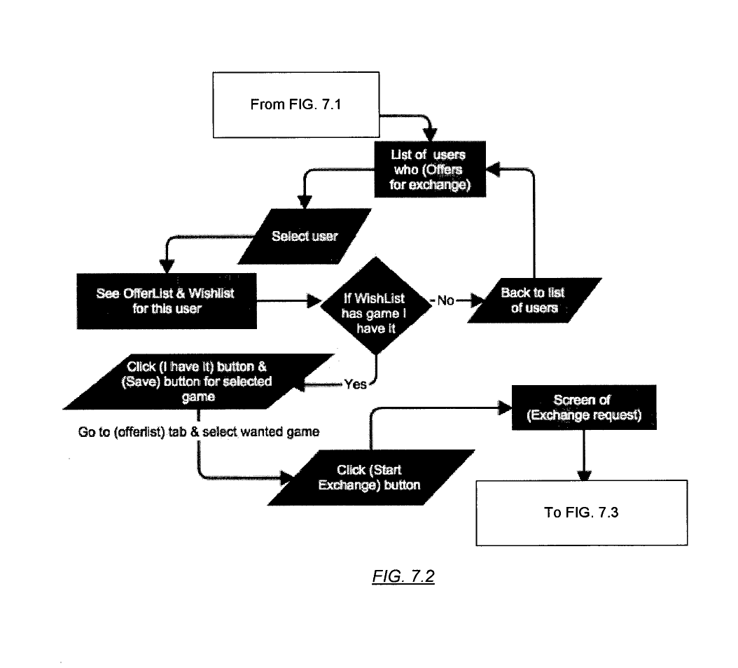

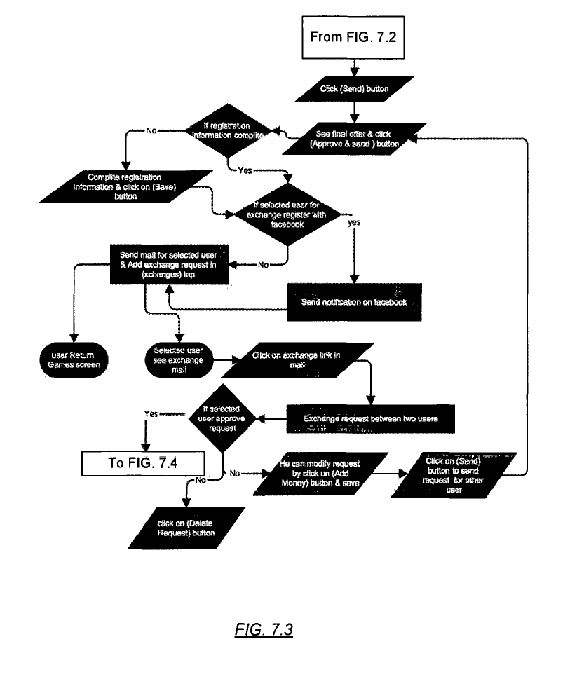

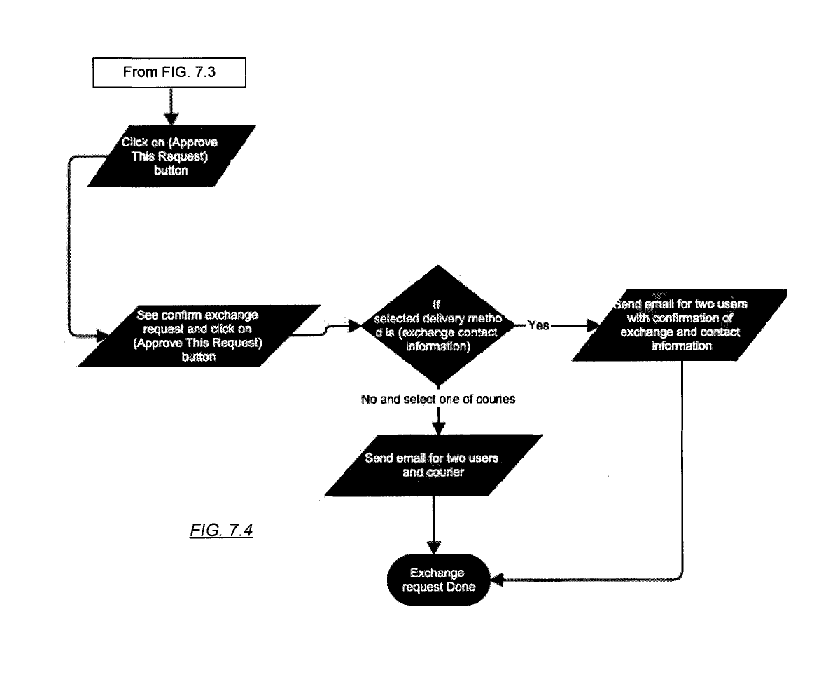

FIGS. 7.1, 7.2, 7.3, and 7.4 show an example of workflow to exchange games on the exchange computing device system in accordance with one or more embodiments of the invention. Embodiments of the invention has many advantages over the prior art, including (but not limited to) the following.

The process of one or more embodiments of the invention facilitates the concept of buying, selling, and/or bartering in a revolutionary way by allowing a user to add his/her existing items in an platform with predictive text that will allow the user to put the items in an offer list.

As items are added, which is accomplished by entering a predictive text-enabled feature or using image recognition technology, the user is able to obverse similar items posted with a listed price range in terms of min/max as well as average price and condition of the item. This feature enables the user to place the marketable product within the correct range or at a “fair value”. The system may also provide the user “fair price” recommendations based on an algorithm that takes into account at least the following subsets of data: age of the product, condition of the product, net cost matrix that will enable comparison on a like for like basis (excluding shipping and charges that may vary based on location), and depth of availability of stock (meaning if the item is fast moving and there is limited stock, the system prioritizes the same in the algorithm), number of successful transactions done by the offering party, rating average with more favorable high rating+high level of transactions.

For buyers, an algorithm consolidating the above subsets of data gives each seller a “fair price” index allowing the buyers to choose a desired item from a specific seller. For sellers, once the “fair price” is determined, then the user has the option to position his price vs. “fair price” meaning, he can offer a 10% discount vs. the most recently executed “fair price.”

Once the user adds his/her items, the user is able to choose from multiple categories of a wish list. Again, once the user wishes are entered, the user is able to observe instant options for purchase of similar items, depending on availability. The user will also be able to observe a full view of the same features of max/min and average prices as well as the “fair value” (which in this instance again looks at market value considering age, claimed condition, proximity and estimated shipping, and handling charges. The process heavily depends on geo-coordinates of the potential seller vs. the user as well as the relevant charges involved. At a certain stage, the process includes price comparison to either high-priced retail store items and or “other online platforms” selling prices. This process drives a clear value proposition of the exchange marketplace platform vs. other platforms. By clicking on the item of interest, the user has clarity on internal price comparison, as listed above, side by side with external sites selling the same item.

In addition, the system includes embodiments that favor sellers vs. others based on a historical trend of transactions, in terms of value and their related ratings. The rating primarily works on the basis of value, number of transactions, feedback rating, and lack of any serious complaints as well as “fair value” practice. The later means that the more a user displays items for relatively better value, the more recommended the user becomes. The system ultimately aims to drive for better value for users, eliminating the sometimes unnecessary middle man that would drive for maximum profit.

Once the above steps are accomplished, multiple options are then presented for potential “barter” deals. Those barter deals have several options, including a straight forward sell or purchase from the “offer list” or “wish list”, or bartering any two items that are matched in two users' opposite lists with the balance paid in cash or by some form of credit. Barter of multiple items vs. one or one vs. multiple is possible depending on the number of matches possible between any two users. Whilst in the initial stage this works across similar categories, the algorithm may also work across categories. This feature means that if a user has a watch on an offer list and a motorbike on a wish list, the user can trade as long as someone else has the same inversely listed items. The system also provides possible items based on similarity of category, meaning across different brands, or based on AI (Artificial Intelligence) using search and browsing historical data. In the case of luxury items and or high value items, parameters are set by market, both parties have an option to either request for on-line security guarantee until a “thumbs up” is provided upon receipt of the item, that it is in the right condition and is apparently genuine; or for those who are not experts, “an expert” opinion and possibly certification is given on each article for an additional fee, for full inspection and report. As this system covers multiple types of products, various independent valuators are virtually linked to system allowing the system to instantly offer the service to users.

In certain cases the user may choose an “alert” function where he/she targets a specific deal and or price. This could be set across the various different fields, such as item, price, location, user preference, or time.

Group bartering is possible with the system. For example, customer A (offering z type shoes), customer B (offering x blazer), and customer C (offering y Ski Jacket) are users of the system. On each of their wish lists, customer A has x blazer and customer B has y ski jacket, and customer C has z type shoes. The system allows a triple trade through a hub as it will act as the common user and enable the trade to take place.

Embodiments of the invention may be implemented on a computer system. Any combination of mobile, desktop, server, router, switch, embedded device, or other types of hardware may be used. For example, as shown in FIG. 8.1, the computer system (800) may include one or more computer processors (802), non-persistent storage (804) (e.g., volatile memory, such as random access memory (RAM), cache memory), persistent storage (806) (e.g., a hard disk, an optical drive such as a compact disk (CD) drive or digital versatile disk (DVD) drive, a flash memory, etc.), a communication interface (812) (e.g., Bluetooth interface, infrared interface, network interface, optical interface, etc.), and numerous other elements and functionalities.

The computer processor(s) (802) may be an integrated circuit for processing instructions. For example, the computer processor(s) may be one or more cores or micro-cores of a processor. The computer system (800) may also include one or more input devices (810), such as a touchscreen, keyboard, mouse, microphone, touchpad, electronic pen, or any other type of input device.

The communication interface (812) may include an integrated circuit for connecting the computer system (800) to a network (not shown) (e.g., a local area network (LAN), a wide area network (WAN) such as the Internet, mobile network, or any other type of network) and/or to another device, such as another computing device.

Further, the computer system (800) may include one or more output devices (808), such as a screen (e.g., a liquid crystal display (LCD), a plasma displays, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (802), non-persistent storage (804), and persistent storage (806). Many different types of computer systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computer system (800) in FIG. 8.1 may be connected to or be a part of a network. For example, as shown in FIG. 8.2, the network (820) may include multiple nodes (e.g., node X (822), node Y (824)). Each node may correspond to a computer system, such as the computer system shown in FIG. 8.1, or a group of nodes combined may correspond to the computer system shown in FIG. 8.1. By way of an example, embodiments of the invention may be implemented on a node of a distributed system that is connected to other nodes. By way of another example, embodiments of the invention may be implemented on a distributed computer system having multiple nodes, where each portion of the invention may be located on a different node within the distributed computer system. Further, one or more elements of the aforementioned computer system (800) may be located at a remote location and connected to the other elements over a network.

Although not shown in FIG. 8.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (822), node Y (824)) in the network (820) may be configured to provide services for a client device (826). For example, the nodes may be part of a cloud computer system. The nodes may include functionality to receive requests from the client device (826) and transmit responses to the client device (826). The client device (826) may be a computer system, such as the computer system shown in FIG. 8.1. Further, the client device (826) may include and/or perform all or a portion of one or more embodiments of the invention.

The computer system or group of computer systems described in FIGS. 8.1 and 8.2 may include functionality to perform a variety of operations disclosed herein. For example, the computer system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file.

The computer system in FIG. 8.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g., ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The above description of functions presents only a few examples of functions performed by the computer system of FIG. 8.1 and the nodes and/or client device in FIG. 8.2. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for implementing an exchange market comprising:
gathering, from a first plurality of users, a plurality of wish lists comprising a first plurality of marketable products;
gathering, from a second plurality of users, a plurality of offer lists comprising a second plurality of marketable products;
matching, using a data structure, a selection of marketable products from the plurality of offer lists stored in the data structure to a selection of marketable products from the plurality of wish lists stored in the data structure to identify a plurality of matches;
assigning a ranking value to each of the plurality of matches based on information stored in the data structure;
positioning the plurality of matches according to the ranking value to obtain an ordered list; and
presenting the plurality of matches according to the order list.

2. The method of claim 1, wherein each match of the plurality of matches is at least one selected from a group consisting of one way matches and two way matches.

3. The method of claim 1, further comprising:
calculating the ranking value based on the product information and user information.

4. The method of claim 3, wherein the ranking value is a parameter aggregating multiple value information.

5. The method of claim 1, wherein the data structure is a self-referential table.

6. The method of claim 5, wherein the transaction is performed based on a user input.

7. The method of claim 6, further comprising:
performing a transaction for the selected match based on communication between users.

8. The method of claim 1, further comprising:
receiving a selection of a match from the plurality of matches to obtain a selected match; and
facilitating communication between users in the selected match.

9. The method of claim 1, wherein the ordered list is dynamically adjusted based on user input.

10. An exchange computing device, comprising:
a computer processor;
an exchange market application executing on the computer processor and configured to:
gather, from a first plurality of users, a plurality of wish lists comprising a first plurality of marketable products;
gather, from a second plurality of users, a plurality of offer lists comprising a second plurality of marketable products;
match a selection of marketable products from the plurality of offer lists to a selection of marketable products from the plurality of wish lists to identify a plurality of matches;
assign a ranking value to each of the plurality of matches;
positioning the plurality of matches according to the ranking value to obtain an ordered list; and
present the plurality of matches according to the ordered list.

11. The device of claim 10, wherein each match of the plurality of matches is at least one selected from a group consisting of one way matches and two way matches.

12. The device of claim 10, wherein the exchange market application is further configured to calculate the ranking value based on the product information and user information.

13. The device of claim 12, wherein the ranking value is a parameter aggregating multiple value information stored in a data structure storing the product information and user information.

14. The device of claim 13, wherein the data structure is a self-referential table.

15. The device of claim 14, wherein the transactions are performed based on a user input.

16. The device of claim 15, wherein the exchange market application is further configured to perform a transaction for the selected match based on communication between users.

17. The device of claim 10, wherein the exchange market application is further configured to:
receive a selection of a match from the plurality of matches to obtain a selected match; and
facilitate communication between users in the selected match.

18. The device of claim 10, wherein the ordered list is dynamically adjusted based on input from users.

19. A non-transitory computer readable medium comprising instructions, which when executed on a computer processor, cause a computer to perform:
gathering, from a first plurality of users, a plurality of wish lists comprising a first plurality of marketable products;
gathering, from a second plurality of users, a plurality of offer lists comprising a second plurality of marketable products;
matching a selection of marketable products from the plurality of offer lists to a selection of marketable products from the plurality of wish lists to identify a plurality of matches;
assigning a ranking value to each of the plurality of matches;
positioning the plurality of matches according to the ranking value to obtain an ordered list; and
presenting the plurality of matches according to the ordered list.

20. The non-transitory computer medium of claim 19, wherein each match of the plurality of matches is at least one selected from a group consisting of one way matches and two way matches.

21. The non-transitory computer medium of claim 19, further comprising instructions, which when executed on a computer processor, cause the computer to perform:
calculating the ranking value based on the product information and user information.

22. The non-transitory computer medium of claim 21, wherein the ranking value is a parameter aggregating multiple value information.

23. The non-transitory computer medium of claim 19, further comprising instructions, which when executed on a computer processor, cause the computer to perform:
performing transactions for the plurality of matches based on the ordered list based on user input.

24. The non-transitory computer medium of claim 19, further comprising instructions, which when executed on a computer processor, cause the computer to perform:
receiving a selection of a match from the plurality of matches to obtain a selected match; and
facilitating communication between users in the selected match.

25. The non-transitory computer medium of claim 19, wherein the ordered list is dynamically adjusted based on input from users.
